(19) United States
(12) Patent Application Publication
(10) Pub. No.: US 2013/0254686 A1
(43) Pub. Date: Sep. 26, 2013

(54) AUTO-GENERATION OF USER INTERFACE BY MOBILE TERMINAL AND EQUIPMENT CONTROL SYSTEM USING SAME

(71) Applicant: Jae-Hak Sun, Gyeonggi-do (KR)

(72) Inventor: Jae-Hak Sun, Gyeonggi-do (KR)

(21) Appl. No.: 13/990,628

(22) PCT Filed: Aug. 3, 2011
(86) PCT No.: PCT/KR2011/005693

§ 371 Date: May 30, 2013

(30) Foreign Application Priority Data
Feb. 18, 2011 (KR) 10-2011-0014396

(51) Int. Cl. G06F 3/0481

(52) U.S. Cl. CPC G06F 3/0481
USPC 715/762

(57) ABSTRACT

The present invention relates to a control system for controlling industrial equipment, and more particularly, to an equipment control system for automatically generating a user interface, reading the control information of the applicable equipment, and inspecting or operating the applicable industrial equipment by using a mobile terminal. The auto-generation of the user interface and the equipment control system using the mobile terminal, according to the present invention, comprises: equipment controllers for controlling various types of equipment; a controlled equipment information terminal, which is coupled to an end portion measurement device that is detected and driven by an input/output device of the equipment controller; the mobile terminal for reading and extracting information from the equipment controller or the controlled equipment information terminal, receiving the user interface from a contact service server, and issuing a command for inspecting or driving the applicable equipment; and the contact service server for providing a UI component for the user interface to the mobile terminal, based on the various types of protocol and standard symbols of the equipment controllers and information on the unique characteristics of the mobile terminal.

### CROSS-REFERENCE TO RELATED APPLICATION

This application claims the benefit of Korean Patent Application No. 10-2011-0014396, filed on Feb. 18, 2011 in the Korean Intellectual Property Office, the disclosure of which is incorporated herein by reference.

### FIELD OF THE INVENTION

A control system which controls most of the industrial equipment is operated by a central operation center for effective management, so the system is operated by communicating with central operation center using a mobile communications device when it is necessary to inspect or operate for the equipments in the field.

### BACKGROUND ART

A mobile device with multi media interface (MMI) may be operated, however, a portable laptop is used more often since hardware usage environment differs depending on MMI and the system is heavy.

Various MMI which may be operated in WEB based small terminal environment are developed, however there is inconvenience of using exclusive tool for development in PC based environment to optimize according to the individual equipment and load in the mobile terminal, and of judging the matching relation between the individual equipment on the field and the equipment on the screen.

To compensate this weakness, it is needed to develop a device in which equipment may be operated easily by providing information needed for supervisory control from an individual controller, a control panel, or a lower measuring instrument to the mobile terminal, and by the mobile terminal using this information to automatically generate user interface.

In addition, there is an urgent task of developing an application program which may be operated economically without a separate additional hardware by utilizing Smartphone which is commonly used due to the convenience of providing various services such as location based service, or video.

### DISCLOSURE

### Technical problem

The purpose of the present invention for solving the mentioned problem is to invent a controller with supervisory control information and a communication unit for communication with a mobile terminal, and to construct a service control system for automatically generating a user interface by receiving the supervisory control information from the mobile terminal.

In addition, the purpose is to construct an equipment control system with control equipment information terminal in which RFID, BARCODE, QRCODE etc are embodied to generate a user interface among a detection unit of an end of an equipment terminal, final drive equipment and an existed controller as well as the equipment controller.

### Technical Solution

To solve the problem, the equipment control system using a user interface automatic generator of a mobile terminal in accordance with the present invention include: an equipment controller for controlling various equipments; a control equipment information terminal attached an end measuring instrument driven by an input and output device of the equipment controller; at least one mobile terminal for reading information outputted from the equipment controller or the control equipment information terminal and commanding to inspect or operate a corresponding equipment using a user interface; and a contact server for providing an UI component for the user interface to the mobile terminal depending on information for various protocols and standard UI component, and unique characteristics of the mobile terminal.

In addition, the equipment control system using a user interface automatic generator of a mobile terminal include a control information module for managing a unique identifier for the mobile terminal and the user interface, a code of the standard UI component displayed on the mobile device, a coordinate for displaying the location, a name of the equipment, and an address for controlling a control target equipment; and a communication unit for communicating with the mobile terminal.

The communication unit includes a module for supporting WiFi, CDMA, Bluetooth, or Zigbee for performing the user interface of the mobile terminal.

The control equipment information terminal further includes RFID or BARCODE, or QRCODE having information for accessing to the equipment controller or/and the equipment controller which is already established.

Each control equipment information terminal includes a unique identifier for performing user interface with the mobile terminal, a code of the standard UI component displayed on the mobile device, a coordinate for displaying the location, a name of the equipment, a control information module for managing an address for controlling a control target equipment; and a communication unit for communicating with the mobile terminal.

The control information module includes at least one control item information where item information of a plurality of the control target equipment.

The control item information includes: a UI standard information for performing an identification function in which the control point for the control target equipment is displayed in some form of the user interface (UI) on the mobile terminal; a common UI information comprising a information value in which all user interface component commonly have regardless of the user interface standard information; a individual UI information for displaying each information to be displayed the control target equipment with other user interface type depending on a classification of the UI standard information; and a control point access information for reading a present value as an address for accessing to each control point of the control target equipment and displaying on the user interface, and forwarding an input information of the user interface of a operator as a control command.

The mobile terminal includes a set of the standard component (UI Component) including control properties for the automatic generation of the user interfaces, and a basic template for arranging the set; and reads control information outputted from the equipment controller or the control equipment information terminal, arranges the corresponding standard component onto the basic template according to an order of the standard component after reading the control information of the equipment controller or the control equipment information terminal, and then performs monitoring control for the control target equipment using the arranged a screen of the basic template.

### Advantageous Effects

According to the composition of the present invention, the equipment control system using a user interface automatic generator of a mobile terminal may perform effective equipment operation since information may be read by using a mobile terminal from a control unit attached with a controller having certain information for performing supervisory control and with medium (RFID, BARCODE, QRCODE) obtained by noncontact service by storing certain information and since a user interface may be automatically generated on the mobile terminal.

In addition, additional equipment for equipment inspection and operation is not needed. It is economical since daily, regular business may be perform with common mobile terminal (Smartphone), and also ripple effect is great since the invention may be used by integrating with equipment history, patrol, or location based services.

### DESCRIPTION OF THE DRAWINGS

FIG. 1 is a block diagram of an equipment control system using a user interface automatic generator of a mobile terminal according to the present invention.

FIG. 2 is a block diagram of an equipment controller shown in FIG. 1.

FIG. 3 is a block diagram of a control information module of an equipment controller shown in FIG. 2.

FIG. 4 is a block diagram of a control equipment information terminal shown in FIG. 1.

FIG. 5 is an internal block diagram of a mobile terminal shown in FIG. 1.

FIG. 6 is a data flow chart of an equipment control system using a user interface automatic generator of a mobile terminal according to the present invention.

FIG. 7 is an exemplary screen displayed on a mobile terminal of an equipment control system using a user interface automatic generator of a mobile terminal according to the present invention.

100: PC for integrated supervisory control, 200: A contact service server
300: Control equipment information terminal, 301, 355: A unique identifier
302, 356: A control information module, 350: An equipment controller
351: An input and output device, 352: A central processing unit
353: A communication unit, 354: A memory unit
356a: Control item information, 356b: UI standard information
356c: Common UI information, 356d: Individual UI information
356e: Control point access information, 400: A mobile terminal
401: UI standard module, 402: supplementary service interlocking module
410: A control information storage module, 411: A user designating module
412: A communication module, 420: A screen display control

### BEST MODE

Hereinafter, the structure, the operations and the effects of an equipment control system using a user interface automatic generator of a mobile terminal according to an embodiment of the present invention will be described in detail with reference to the accompanying drawings.

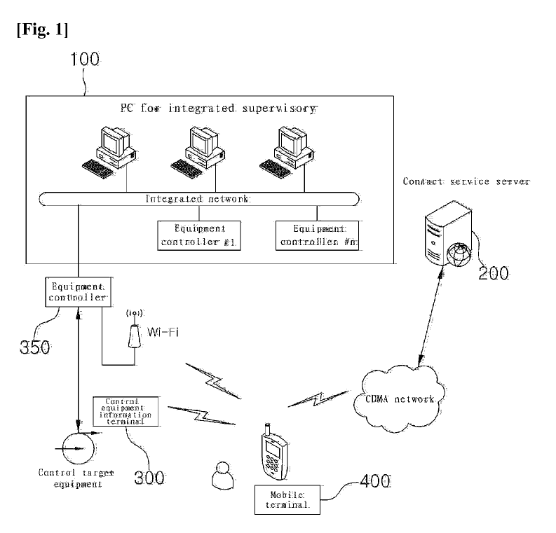

FIG. 1 is a block diagram of an equipment control system using a user interface automatic generator of a mobile terminal according to the present invention.

As illustrated in FIG. 1, an equipment control system using a user interface automatic generator of a mobile terminal includes a PC for integrated supervisory control 100, a contact service server 200, a control equipment information terminal 300, an equipment controller 350, and a mobile terminal 400.

The PC for integrated supervisory control 100 may configure a whole network for operating equipment by conventional equipment operation method in the PC for integrated supervisory control and may configure the equipment in a form of remotely operated.

The contact service server 200 is a server providing different protocol and UI component type depending on various types of the mobile terminal 400 and the equipment controller 350.

The mobile terminal 400 is configured to be used after accessing to the contact service server 200, then downloading and installing the corresponding information when using for the first time.

The mobile terminal 400 may upgrade new function by accessing to the contact service server 200, even if it is not the first time, when there is no function which the equipment controller 350 or the control equipment information terminal 300 requires.

The control equipment information terminal 300 is detected and operated by an input and output device of the equipment controller 350 and is attached in the end measuring instrument or the equipment.

The control equipment information terminal 300 includes RFID, BARCODE or QRCODE having information for accessing to the conventional equipment data and the controller to be used not only when the equipment controller 350 is constructed but also in existing regular controller. The control equipment information terminal further includes information in the same form of the control information module of the memory unit which is built in the equipment controller 350.

The equipment controller 350 networks with the PC for integrated supervisory control, includes a wireless communication module (WiFi, CDMA, Bluetooth, or Zigbee) for wireless communication with a mobile terminal 400, and includes a control information module having unique identifier information for interface with a mobile terminal 400 and the corresponding equipment information for monitoring the corresponding equipment. The mobile terminal 400 includes the UI information (UI executing after downloading from the contact service server 200), an equipment controller 350, and a wireless device for wireless access (WiFi, CDMA, Bluetooth, or Zigbee).

This system (the equipment controller 350 and the control equipment information terminal 300) may use the mobile terminal 400 in front of the control target equipment and use the wireless network of the equipment controller 350 to read UI information, configure the screen automatically, and inspect or operate the equipment by using the configured screen.

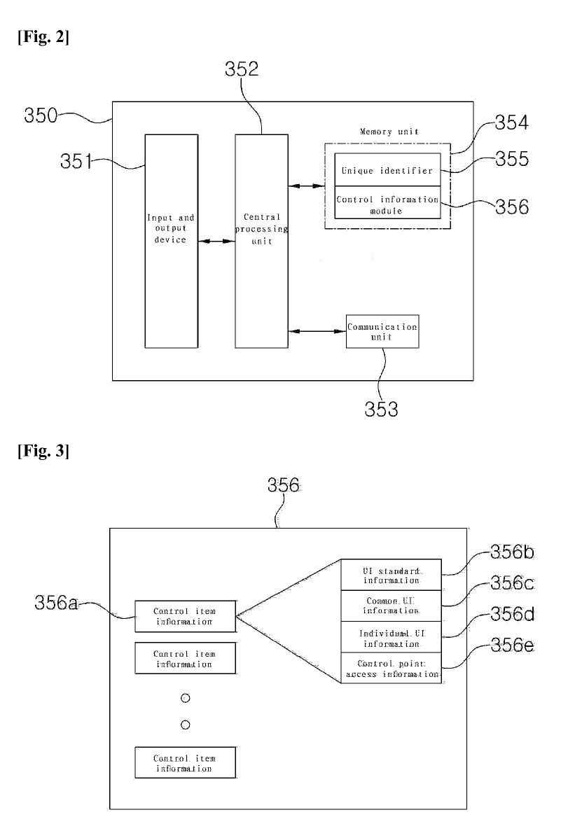

FIG. 2 is a block diagram of an equipment controller shown in FIG. 1.

As illustrated in FIG. 2, the equipment controller 350 includes an input and output device 351, a central processing unit 352, a communication unit 353, and a memory unit 354. The communication unit 353 includes ordinary wireless module (Zigbee, WiFi, Bluetooth, CDMA, or RFID) supported by the mobile terminal 400 for noncontact service with the mobile terminal.

The memory unit 354 includes a unique identifier 355 and a control information module 356 for interface with the mobile terminal 400.

The wireless module provides unique identifier 355 and control information module 356 to each wireless module standard protocol in text form when communicating with the mobile terminal 400 for screen layout, and the communication for controlling the input and output device 351 after the screen layout uses exclusive protocol of the equipment controller 350. The equipment controller 350 uses Modbus which is an open industrial protocol.

The unique identifier 355 of the memory unit 354 has an IP, a port, and a protocol name for controlling the input and output device 351 of the equipment controller 350, and this information is used when accessing for control after configuring the auto-screen on the mobile terminal 400.

The control information module 356 includes a module having information for screen layout of the mobile terminal 400.

The memory unit 354 of the equipment controller 350 and the control equipment information terminal 300 has identical function except the different characteristic of record medium, and the configuration of the control equipment information terminal 300 is replaced with the description of the memory unit 354.

FIG. 3 is a block diagram of a control information module of an equipment controller shown in FIG. 2.

As illustrated in FIG. 3, the control information module 356 includes at least one control item information 356a, and each item information 356a includes UI standard information 356b, common UI information 356c, individual UI information 356d, and control point access information 356e.

The control item information 356a includes at least one, and a plurality of control item information 356a may be configured since there are generally a plurality of control targets (equipment).

The control item information 356a provides specific information for accessing directly to each input and output information which may be monitored or controlled through the equipment controller 350.

The control item information 356a includes “UI standard information 356b”, “common UI information 356c”, “individual UI information 356d”, and “control point access information 356e”, and detail description are as follows.

Since “the UI standard information 356b” is needed to be displayed in different form of UI depending on each control point function and control value within the control target device, “UI standard information 356b” may display an identification function in which the control point be displayed with UI of any form on the mobile terminal 400.

“The common UI information 356c” includes a information value such as coordinate on the terminal or a name of the equipment in which all UI components commonly have regardless of the user interface standard information 356b for performing an identification function in which the control point for the control target equipment is displayed in some form of the UI on the mobile terminal 400.

“Individual UI information 356d” is displayed in different form of UI depending on the identifier of the each control point “UI standard information 356b” of the mobile terminal 400, and accordingly separated information is needed.

For example, the temperature and the operation current of the control target equipment are included in “individual UI information 356d” since these information need range of minimum value or maximum value to increase readability of UI.

“Control point access information 356e” reads a present value as an address for accessing to each control point of the control target equipment of the equipment controller 350 on the mobile terminal 400 and displays on the UI, and forwards input information of the user interface of a operator as a control command.

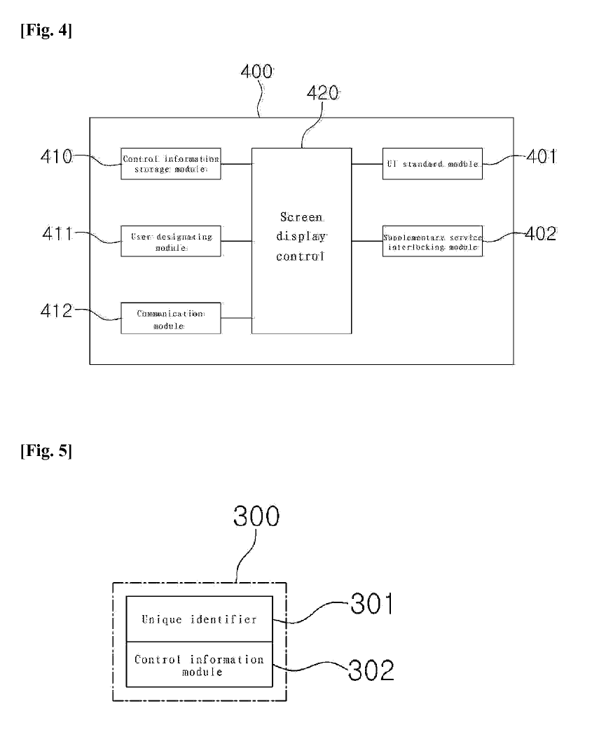

FIG. 4 is a block diagram of a control equipment information terminal shown in FIG. 1. As illustrated, the control equipment information terminal 300 includes RFID, BARCODE or QRCODE having information for accessing to conventional equipment data and controller, and includes information in the same form of the memory unit 354 of the equipment controller 350.

The unique identifier 301 and the control information module 302 have the same characteristic with the memory unit 354 of the equipment controller 350, read information of control equipment information terminal 300 in front of the control target equipment in the mobile terminal 400, and use the information to communicate with the equipment controller 350 to perform supervisory control.

FIG. 5 is an internal block diagram of a mobile terminal shown in FIG. 1.

As illustrated in FIG. 5, the mobile terminal 400 includes an UI standard model 401, a supplementary service interlocking module 402, a control information storage module 410, a user designating module 411, a communication module 412, and a screen display control 420.

If choosing the corresponding equipment accessed to the mobile terminal 400, “control information modules 302 and 356” may be stored in “control information storage module 410” of the mobile terminal 400 through “communication module 412”.

“The screen display control 420” calls corresponding UI from “UI standard module 401” by using “control item 356a” information with a template of basic structure on screen layout and arranges UI in the template of “screen display control 420” in order of “control item information 356a”.

“The user designating module 411” omits process of obtaining control information by storing an user basic setup and an user designating equipment name for enhancing screen-readability, also storing “control information storage module” by the choice of the user, and accessing to the initial controller, and immediately performs input and output control of the controller.

“The supplementary service interlocking module 402” is a module interlocking with the function supported by the mobile terminal, transmits the location of the equipment interlocking with the present GPS and operation condition of the equipment through SMS with GPS, SMS, and video service and uses the real time video call service to receive advice on the equipment from expert in remote distance.

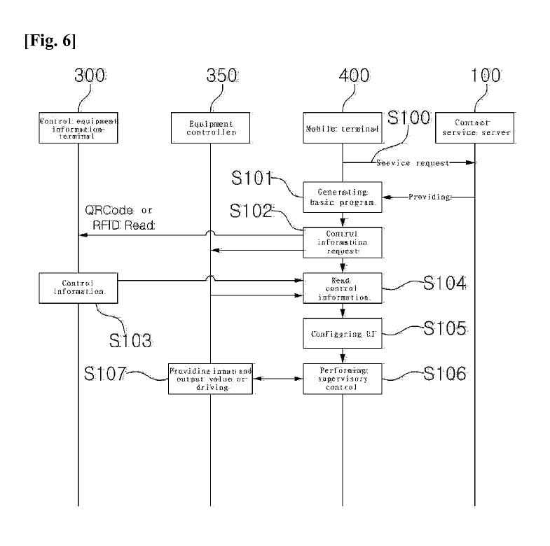

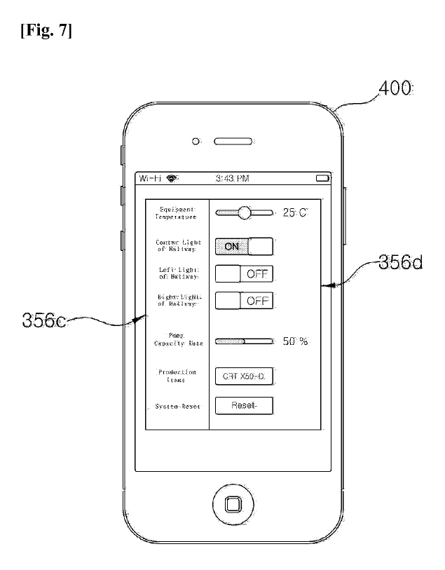

FIG. 6 is a flow chart of an equipment control system using a user interface automatic generator of a mobile terminal according to the present invention.

First, when there is no basic program for screen generation in the mobile terminal 40, the program is directly installed in the mobile terminal 400 or downloaded the program after accessing the contact service server 100 and filing service request at S100.

The basic program is generated at S101, and then file control information request to the control equipment information terminal 300 or the equipment controller 350 after executing the program at S102.

In case of filing control information request to the control equipment information terminal 300, the control information is read using the mobile terminal 400 at S103, the control information of device which is read is interpreted, and accordingly the UI is configured at S104.

In case of filing control information request to the equipment controller 350, the control information provided from the equipment controller 350 is read using the mobile terminal 400 S103, the control information of device which is read is interrupted, and accordingly the UI is configured at S104.

When UI configuration S105 is completed UI, the UI access to the equipment controller 350, reads condition information value of the target device depending of the characteristic of the UI, displays the condition information value on the UI, or perform supervisory control on the target device through UI input of the user at S106.

The equipment controller 350 provides or operates the input and output value depending on the supervisory control command of the mobile terminal 400 at S106 and S107. FIG. 7 is an exemplary screen displayed on a mobile terminal of an equipment control system using a user interface automatic generator of a mobile terminal according to the present invention.

As illustrated in FIG. 7, the mobile terminal 400 may display the present value by configuring UI on a plurality of control item by using “control information module 356” which is read from the control target device (control equipment information terminal 300, and equipment controller 350), and may be input with UI of the user.

For example, example of data on “control item information 356a” of top two items on the illustrated screen may be configured as follows.

Example of “Device Temperature” Item

| Items | Data Contents | Remarks |
|---|---|---|
| UI standard information | “progress Bar” | |
| Common UI information | (x = 10, Y = 30), Tag=” | |
| | Equipment Temperature” | |
| Individual UI information | Barwidth = 100, | Min/Max Value |
| | Color = Blue/White | |
| Control point access | PointAddr = 0x3004, | |
| information | Length = 1 Byte | |

Example of “Center Light of Hallway” Item“

| Items | Data Contents | Remarks |
|---|---|---|
| UI standard information | “On/Off Button” | |
| Common UI information | (x = 10, Y = 30), Tag=” Center | |
| | Light of Hallway” | |
| Individual UI information | ButtonStyl = Plain | |
| Control point access | PointAddr = 0x1104, | |
| information | Length = 1 Bit | |

According to the present invention, the equipment control system using a user interface automatic generator of a mobile terminal may perform effective equipment operation since information may be read by using the mobile terminal from the control unit attached with the controller having certain information for performing supervisory control and with medium (RFID, BARCODE, QRCODE) obtained by noncontact service by storing certain information and since a user interface may be automatically generated on the mobile terminal.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

1. An equipment control system using a user interface (UI) automatic generator of a mobile terminal; the equipment control system comprising:
an equipment controller for controlling various equipment;
a control equipment information terminal attached to an end measuring instrument driven by an input and output device of the equipment controller;
at least one mobile terminal for reading information outputted from the equipment controller or the control equipment information terminal and commanding to check or operate a corresponding equipment using a user interface; and
a contact server for providing a UI component for the user interface to the mobile terminal depending on information for various protocols and standard UI components, and a unique characteristic of the mobile terminal;
wherein each of the equipment controller or the control equipment information terminal includes a control information module for managing a unique identifier for the mobile terminal and the user interface, a code of the standard UI component displayed on the mobile device, a coordinate for displaying the location, a name of the equipment, and an address for controlling a control target equipment; and a communication unit for communicating with the mobile terminal.

2. The equipment control system according to claim 1, wherein the communication unit comprises a communication module for supporting WiFi, CDMA, Bluetooth, or Zigbee for performing the user interface of the mobile terminal.

3. The equipment control system according to claim 1, wherein the control equipment information terminal recognizes RFID, BAR Code, or QR Code having information for accessing the equipment controller or/and the equipment controller which is already established.

4. The equipment control system according to claim 1, wherein the control information module comprises at least one control item information where an item information of a plurality of the control target equipment is written.

5. The equipment control system according to claim 4, wherein the control item information comprises:
a UI standard information for performing an identification function in which the control point for the control target equipment is displayed in some form of the user interface (UI) on the mobile terminal;
a common UI information comprising an information value which all user interface components commonly have regardless of the user interface standard information;
an individual UI information for displaying each information to be displayed on the control target equipment with other user interface type depending on a classification of the UI standard information; and
a control point access information for reading a present value as an address for accessing each control point of the control target equipment and displaying on the user interface, and forwarding an input information of the user interface of an operator as a control command.

6. The equipment control system according to claim 1, wherein the mobile terminal comprises a set of the standard component (UI Component) including control properties for the automatic generation of the user interfaces, and a basic template for arranging the set; and reads control information outputted from the equipment controller or the control equipment information terminal, arranges the corresponding standard component onto the basic template according to an order of the standard component after reading the control information of the equipment controller or the control equipment information terminal, and then performs monitoring control for the control target equipment using the arranged a screen of the basic template.
